(19) United States
(12) Patent Application Publication
(10) Pub. No.: US 2011/0060985 A1
(43) Pub. Date: Mar. 10, 2011

(54) System and Method for Collecting a Signature Using a Smart Device

(75) Inventors: Joshua A. Kerr, Austin, TX (US); Alexander J. Bibighaus, IV, Austin, TX (US)

(73) Assignee: ABJK Newco, Inc., Austin, TX (US)

(21) Appl. No.: 12/555,667

(22) Filed: Sep. 8, 2009

(51) Int. Cl. G06F 3/01; G06F 3/048

(52) U.S. Cl. 715/702; 715/784

(57) ABSTRACT

A system and method for collecting a signature using a smart device are disclosed. A signature module executing on a smart device may allow a user to input a signature via the smart device display with a pixel size larger than then pixel size of the smart device by causing a viewable portion of a signature file to scroll relative to the display while the user is inputting the signature. In addition, the signature module may display to the user with an interactive pen tool, that functions as a “virtual pen” to allow a user greater control over inputting his or her signature into the smart device. After a signature has been captured, a document viewer module executing on the smart device may allow a user to appropriately position and size the signature for placement in a document being viewed on a smart device.

### TECHNICAL FIELD

The present disclosure relates in general to smart devices, and more particularly to systems and methods for collecting a signature using a smart device.

### BACKGROUND

As communications and computer technology has advanced, users are increasingly using smart devices (e.g., cell phones, personal digital assistances, mobile computers, etc.) for entertainment and the conduct of business. Advances such as electronic mail, the Internet, and portable document formats have also enabled the efficient electronic transmission of documents between individuals.

The application or addition of a written signature to a document is often desirable as a means to indicate an individual's assent or approval to the contents of the document (e.g., a signature on a contract, letter, form, or other document), and in many cases is required for a document to be legally binding in many legal jurisdictions. However, traditional smart phones often do not allow a user to apply or add a written signature to a document otherwise accessible or viewable by the user via a smart device. In addition, touchscreens available on modern smart devices are often small and do not often provide a large area to allow a user to sign his or her name. Furthermore, because the size of a user's fingertip is typically larger than that of a writing device such as a pen or pencil, the use of a fingertip to make a signature may cause an aesthetically unappealing signature, or a signature that deviates significantly in appearance from a user's traditional “pen-on-paper” signature. While the use of a stylus may overcome such a disadvantage, many smart devices do not include styluses, and many users of smart devices prefer not to transport additional equipment for use of their smart devices.

### SUMMARY

In accordance with the teachings of the present disclosure, disadvantages and problems associated with collecting a signature using a smart device may be substantially reduced or eliminated.

Accordingly to at least one embodiment of the present disclosure, a signature module executing on a smart device may allow a user to input a signature via the smart device display with a pixel size larger than then pixel size of the smart device by causing a viewable portion of a signature file to scroll relative to the display while the user is inputting the signature. In addition, the signature module may display to the user with an interactive pen tool, that functions as a “virtual pen” to allow a user greater control over inputting his or her signature into the smart device. After a signature has been captured, a document viewer module executing on the smart device may allow a user to appropriately position and size the signature for placement in a document being viewed on a smart device.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example smart device, in accordance with one or more embodiments of the present disclosure;

FIGS. 2A-2D illustrate a flow chart of an example method for displaying a document on a smart device and collecting data for insertion into the document, in accordance with one or more embodiments of the present disclosure;

FIGS. 3A-3K illustrate various user interface display screens that may be displayed to a user of a smart device, in accordance with one or more embodiments of the present disclosure;

FIGS. 4A-4D illustrate a flow chart of an example method for collecting a signature for insertion into a document, in accordance with one or more embodiments of the present disclosure;

FIGS. 5A-5D and 7A-8E illustrate various user interface display screens that may be displayed to a user of a smart device, in accordance with one or more embodiments of the present disclosure; and

FIGS. 6A-6C illustrate contents of an image file that may be used to store information regarding a user signature, in accordance with one or more embodiments of the present disclosure.

### DETAILED DESCRIPTION

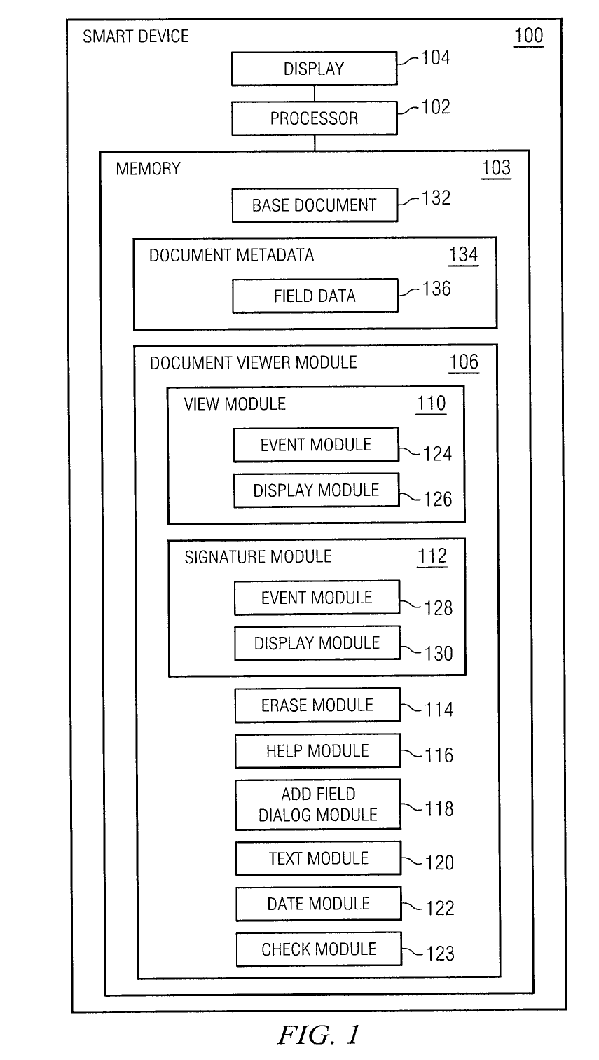

Preferred embodiments and their advantages are best understood by reference to FIGS. 1-8E, wherein like numbers are used to indicate like and corresponding parts.

For purposes of this disclosure, a smart device may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an smart device may be a personal computer, a smart phone (e.g., a Blackberry or iPhone), a personal digital assistant, or any other suitable device and may vary in size, shape, performance, functionality, and price. The smart device may include random access memory (RAM), one or more processing resources such as a central processing unit (CPU) or hardware or software control logic, ROM, and/or other types of nonvolatile memory. Additional components of the smart device may include one or more disk drives, one or more network ports for communicating with external devices as well as various input and output (I/O) devices, such as a touchscreen and/or a video display. The smart device may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

FIG. 1 illustrates a block diagram of an example smart device 102, in accordance with one or more embodiments of the present disclosure. As depicted in FIG. 1, smart device 102 may include a processor 102, a memory 103, and a display 104.

Processor 102 may comprise any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 102 may interpret and/or execute program instructions and/or process data stored in memory 103 and/or another component of smart device 100. In the same or alternative embodiments, processor 102 may communicate data for display to a user on display 104.

Memory 103 may be communicatively coupled to processor 102 and may comprise any system, device, or apparatus configured to retain program instructions or data for a period of time (e.g., computer-readable media). Memory 103 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to smart device 100 is turned off.

As shown in FIG. 1, memory 103 may have stored thereon a document viewer module 106, a base document 132, and document metadata 134. Document viewer module 106 may include one or more programs of instructions that when, executed by processor 102, may be configured to display contents of an electronic document to display 104 and permit manipulation of the electronic document based on touch events occurring at display 104, as described in further detail below. Although depicted as a program of instructions embodied in memory 103, all or a portion of document viewer module 106 may embodied in hardware, firmware, or software stored on a computer-readable medium (e.g., memory 103 or computer-readable media external to memory 103).

Document viewer module 106 may include any number of sub-modules configured to execute or perform specific tasks related to the functionality of document viewer module 106, as described in greater detail below. For example, document viewer module may include a view module 110, a signature module 112, an erase module 114, a help module 116, an add field dialog module 118, a text module 120, a date module 122, and a check module 123.

View module 110 may include one or more programs of instructions that when, executed by processor 102, may be configured to display contents of an electronic document to display 104 and process user instructions for manipulation of the electronic document based on touch events occurring at display 104, as described in further detail below. View module 110 may itself include its own sub-modules configured to execute or perform specific tasks related to the functionality of view module 110. For example, view module 110 may include an event module 124 and a display module 126. Event module 124 may include one or more programs of instructions that, when executed by processor 102, may be configured to monitor for touch events occurring at display 104, process any such events, and store data to memory 103 and/or another computer-readable medium based on such events. Display module 126 may include one or more programs of instructions that, when executed by processor 102, may be configured to read data from memory 103 and/or another computer-readable medium and process the data for display on display 104. In certain embodiments, view module 110 may be invoked automatically when document viewer module 106 is executed, and view module 110 may serve as the “main” or “central” module which may branch to other modules described herein based on user input at display 104.

Signature module 112 may include one or more programs of instructions that when, executed by processor 102, may be configured to display graphical components to display 104 to facilitate the collection of a user signature and to monitor and process touch events at display 104 in order to store an electronic representation of the user's signature for use in connection with the document. In some embodiments, signature module 112 may be invoked when view module 110, add field dialog module 118, or another module detects an event at display 110 indicating that a user desires to add a signature to the electronic document being viewed within document viewer module 106. Similar to view module 110, signature module 112 may itself include its own sub-modules configured to execute or perform specific tasks related to the functionality of signature module 112. For example, signature module 112 may include an event module 128 and a display module 130. Event module 128 may include one or more programs of instructions that when, executed by processor 102, may be configured to monitor for touch events occurring at display 104, process any such events, and store data to memory 103 and/or another computer-readable medium based on such events. Display module 130 may include one or more programs of instructions that when, executed by processor 102, may be configured to read data from memory 103 and/or another computer-readable medium and process the data for display on display 104.

Erase module 114 may include one or more programs of instructions that when, executed by processor 102, may be configured to erase or clear metadata associated with a document being viewed in document viewer module 106. In some embodiments, erase module 114 may be invoked when view module 110 or another module detects an event at display 110 indicating that a user desires to erase all or a portion of the electronic document being viewed within document viewer module 106.

Help module 116 may include one or more programs of instructions that when, executed by processor 102, may be configured to display via display 104 graphics and/or alphanumeric text to instruct a user as to the use of document viewer module 106. In some embodiments, help module 116 may be invoked when view module 110 or another module detects an event at display 110 indicating that a user desires to invoke help module 116.

Add field dialog module 118 may include one or more programs of instructions that when, executed by processor 102, may be configured to display via display 104 graphics and/or alphanumeric text presenting a user with options regarding the addition of a field (e.g., signature field, text field, date field, check field, etc.) to the document being viewed within document viewer module 106. In some embodiments, add field dialog module 118 may be invoked when view module 110 or another module detects an event at display 110 indicating that a user desires to add a field to the electronic document being viewed within document viewer module 106.

Text module 120 may include one or more programs of instructions that when, executed by processor 102, may be configured to display graphical components to display 104 to facilitate the input of text and to monitor and process touch events at display 104 in order to store a field of text in connection with the document. In some embodiments, text module 120 may be invoked when view module 110, add field dialog module 118, or another module detects an event at display 110 indicating that a user desires to add text to the electronic document being viewed within document viewer module 106.

Date module 122 may include one or more programs of instructions that when, executed by processor 102, may be configured to display graphical components to display 104 to facilitate the placement of a date field within the document being viewed within document viewer module 106 and to monitor and process touch events at display 104 in order to store a field including a date in connection with the document. In some embodiments, date module 122 may be invoked when view module 110, add field dialog module 118, or another module detects an event at display 110 indicating that a user desires to add a date to the electronic document being viewed within document viewer module 106.

Check module 123 may include one or more programs of instructions that when, executed by processor 102, may be configured to display graphical components to display 104 to facilitate the placement of a check mark, check box, and/or similar mark within the document being viewed within document viewer module 106 and to monitor and process touch events at display 104 in order to store a field including a check mark, check box, and/or similar mark in connection with the document. In some embodiments, check module 123 may be invoked when view module 110, add field dialog module 118, or another module detects an event at display 110 indicating that a user desires to add a check mark, check box, and/or similar mark to the electronic document being viewed within document viewer module 106.

For simplicity, each of erase module 114, help module 116, add field dialog module 118, text module 120, date module 122, and check module 123 are shown in FIG. 1 as not including any sub-modules (e.g., event modules or display modules). However, each of such modules may include any suitable sub-modules, including, without limitation, event modules and/or display modules identical or similar to event module 124, event module 128, display module 126, and/or display module 130.

Although each of view module 110, signature module 112, erase module 114, help module 116, add field dialog module 118, text module 120 are described above as one or more programs of instructions embodied in memory 103, all or a portion of each of view module 110, signature module 112, erase module 114, help module 116, add field dialog module 118, text module 120, date module 122, and check module 123 may embodied in hardware, firmware, or software stored on a computer-readable medium (e.g., memory 103 or computer-readable media external to memory 103).

Base document 132 may include any file, database, table, and/or other data structure which may be embodied as data stored in a computer-readable medium (e.g., an electronic document or electronic file). In some embodiments, base document 132 may comprise a document compliant with the Portable Document Format (PDF) standard or other suitable standard.

Document metadata 134 may include any file, database, table, and/or other data structure that includes information regarding data stored within and/or associated with base document 132. For example, field data 136 of document metadata 134 may include information regarding certain fields of data related to base document 132 (e.g., a signature field, text field, date field, check field, or other information added to the base document 132 by a user of smart device 100). Such information may include data representations of the contents of fields of data (e.g., ASCII text, bitmaps, raster images, etc.), data regarding the size of the fields of data, data regarding coordinates within the base document 132 that the fields of data are located, and/or any other suitable data. For example, document metadata for a user signature associated with the base document 132 may include a bitmap representing the signature, variables regarding the size of the bitmap, and/or coordinates regarding the placement of the signature within the base document 132.

Display 104 may be coupled to processor 102 and may include any system, apparatus, or device suitable for creating graphic images and/or alphanumeric characters recognizable to a user and for detecting the presence and/or location of a tactile touch within the display area. Display 104 may include, for example, a liquid crystal display (LCD), a light-emitting diode (LED) display, or an organic LED display, and may employ any suitable mechanism for detecting the presence and/or location of a tactile touch, including, for example, resistive sensing, capacitive sensing, surface acoustic wave, projected capacitance, infrared, strain gauge, optical imaging, dispersive signal technology, or acoustic pulse recognition.

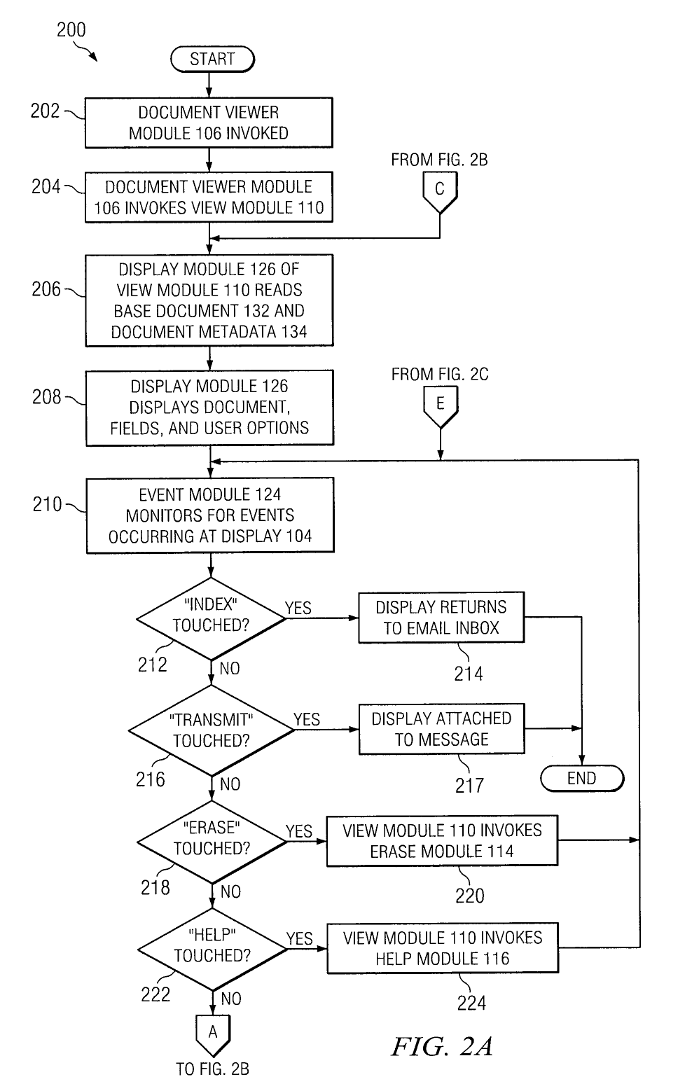

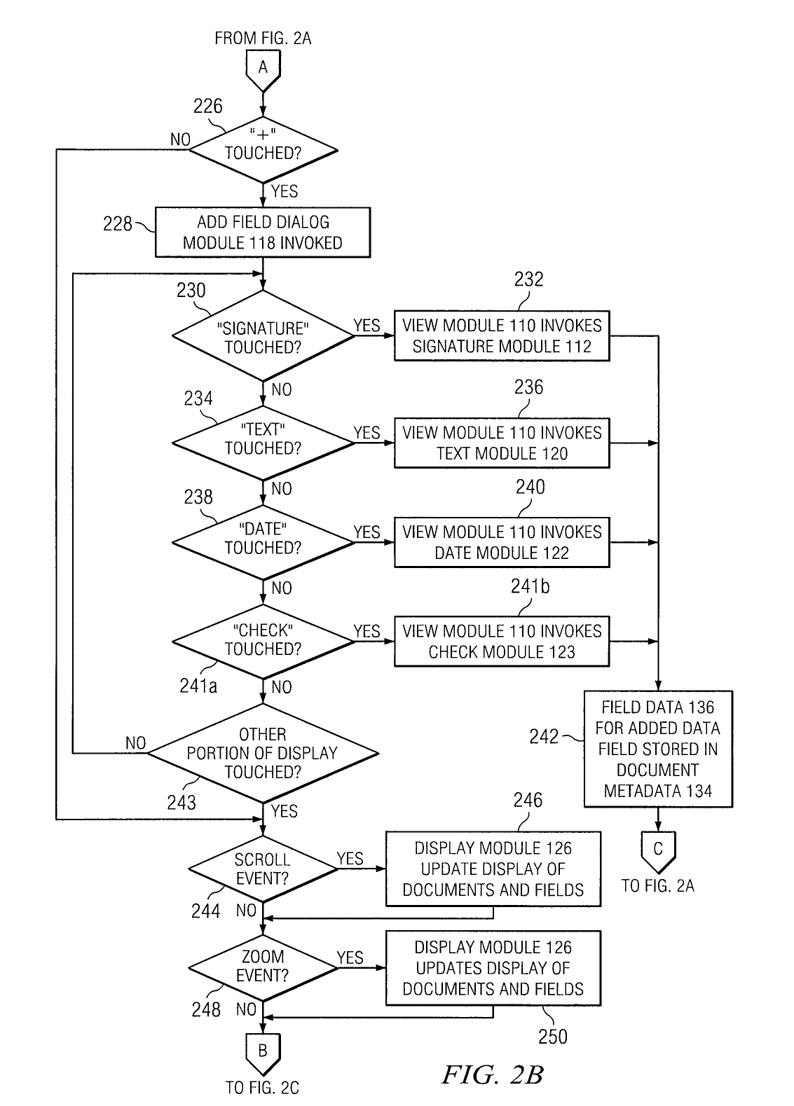

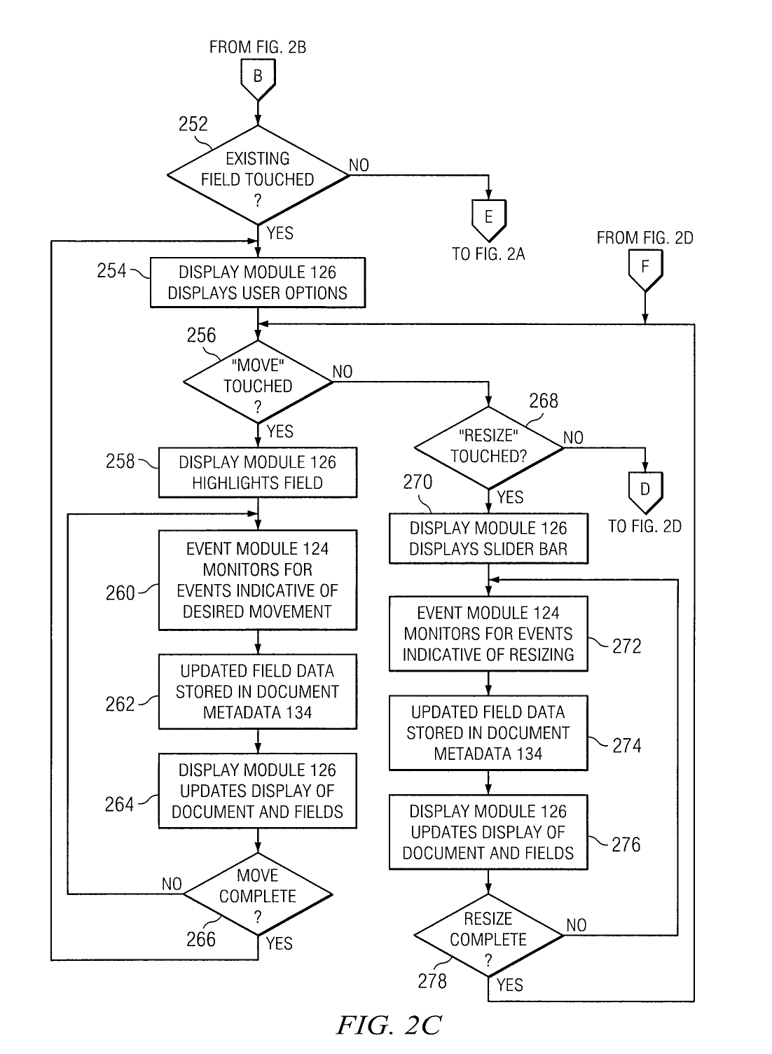

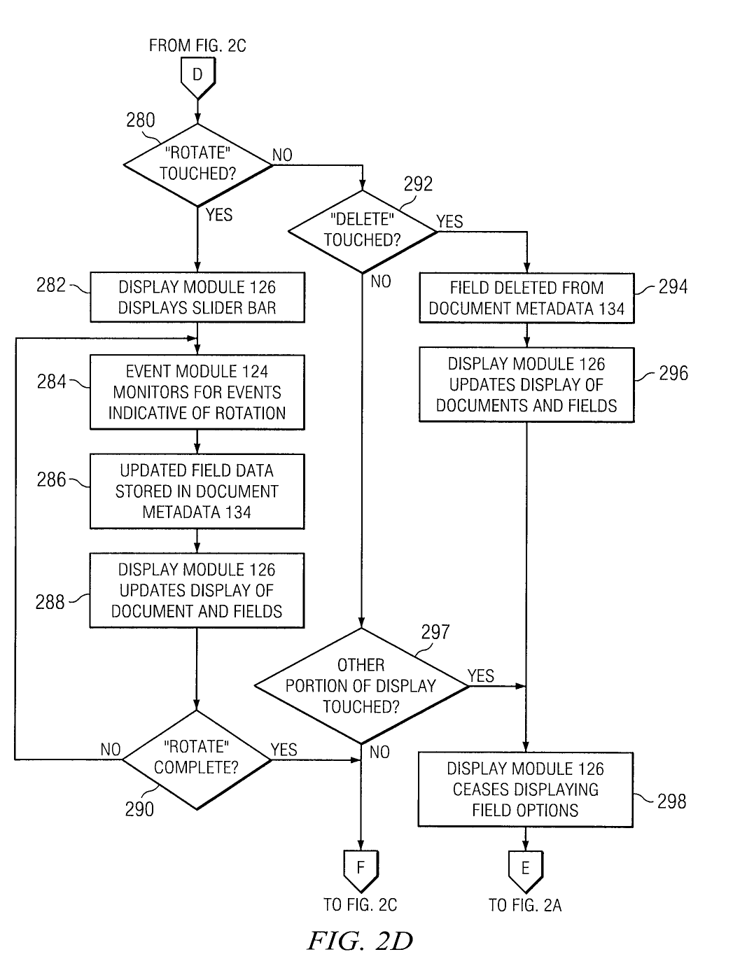

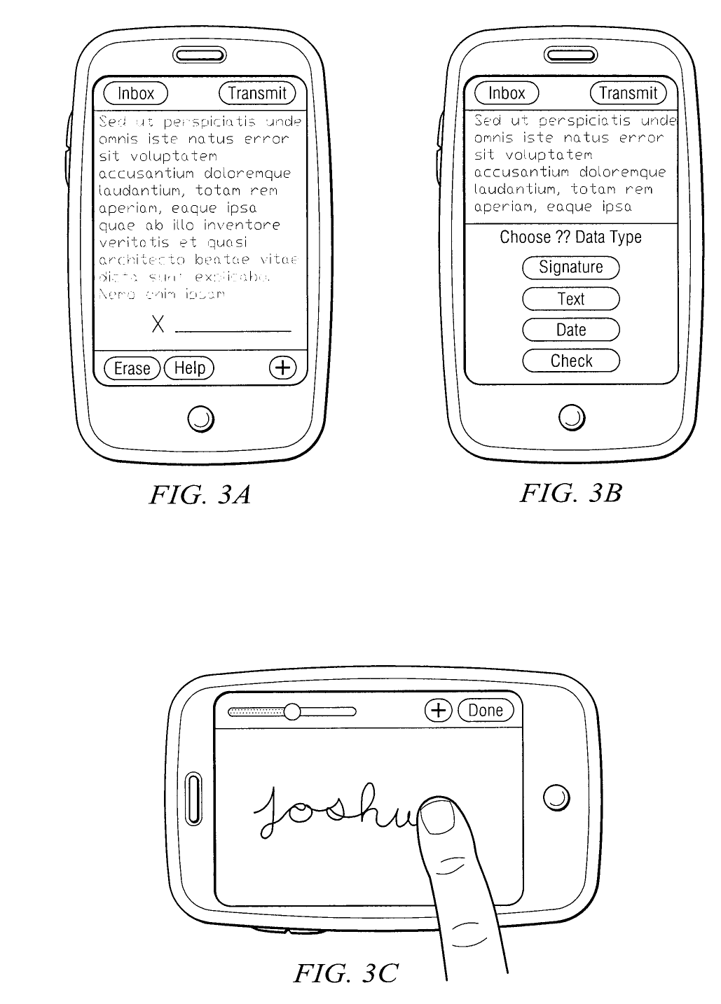

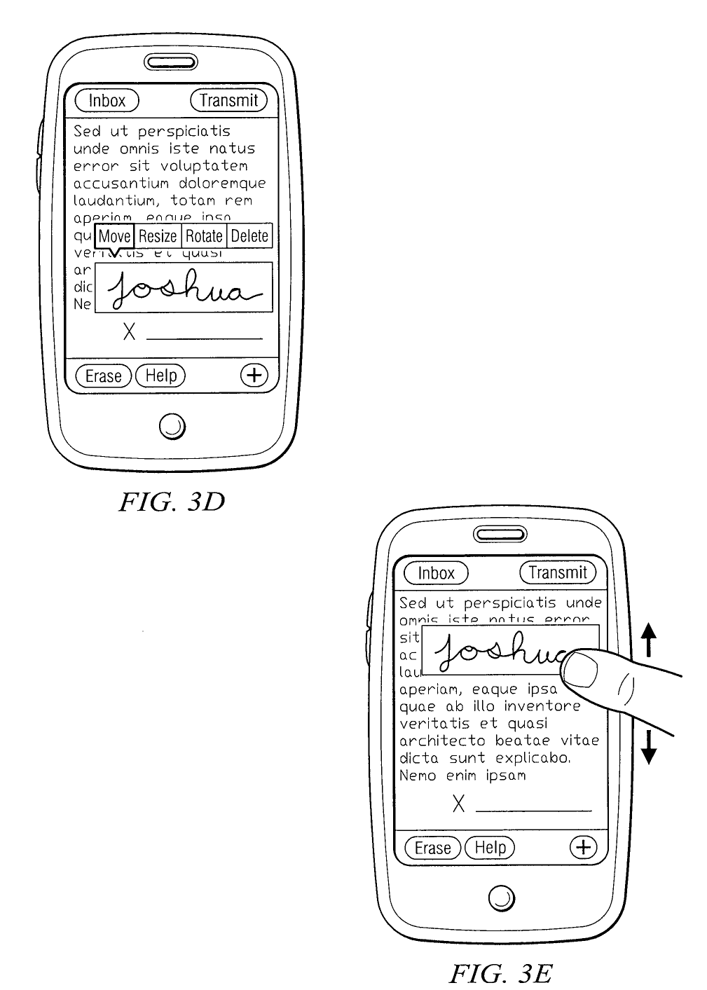

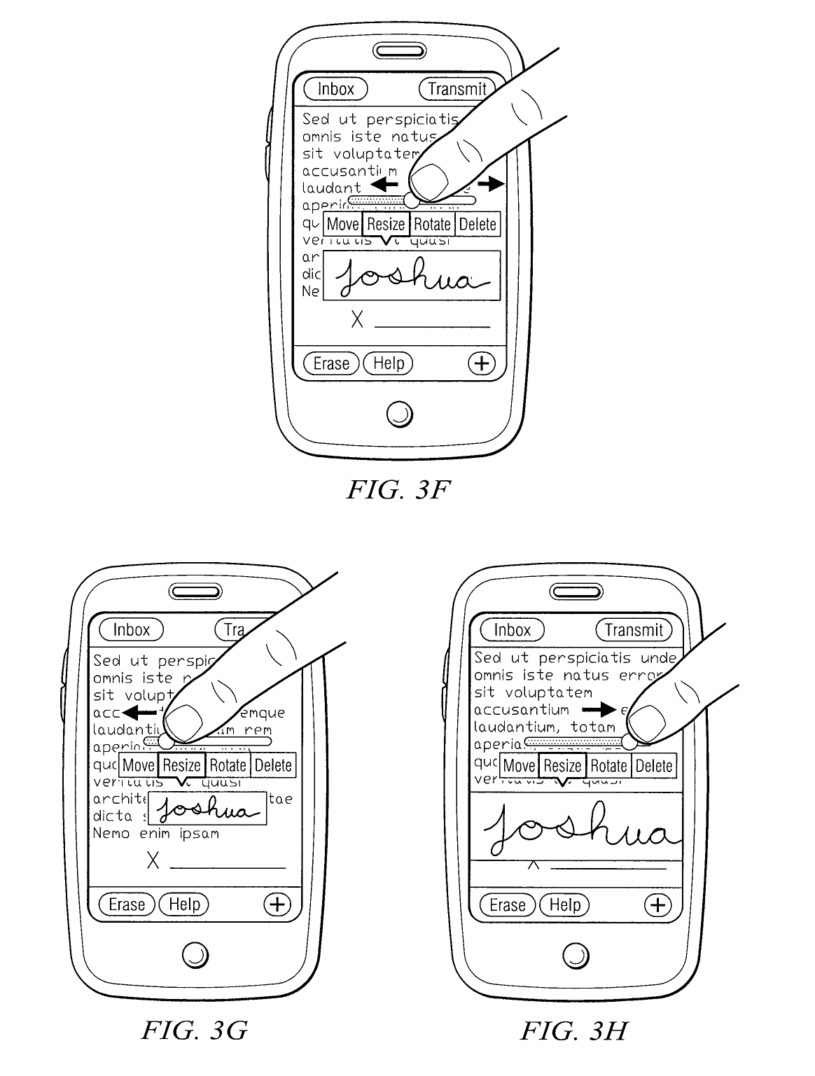

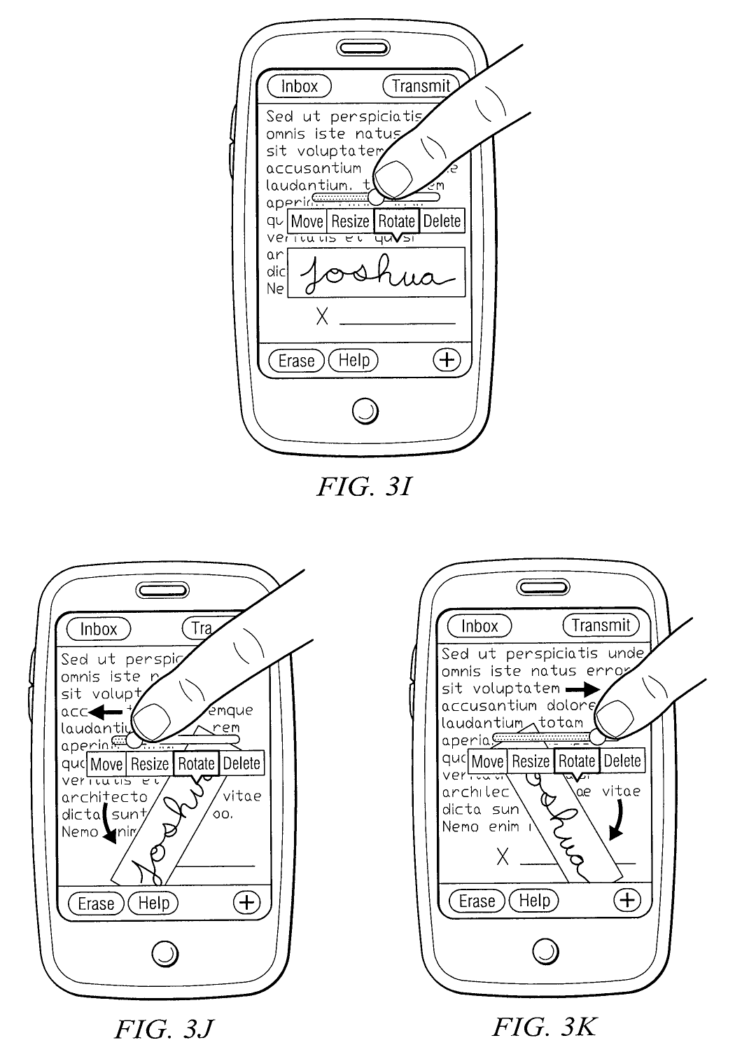

The functionality of document viewer module 106 be better illustrated by reference to FIGS. 2A-2D and 3A-3K. FIGS. 2A-2D illustrate a flow chart of an example method 200 for displaying a document (e.g., base document 132 and associated document metadata 134) on a smart device 100 and collecting data for insertion into the document, in accordance with one or more embodiments of the present disclosure. FIGS. 3A-3K illustrate various user interface display screens that may be displayed to a user of a smart device 100 during operation of method 200, in accordance with one or more embodiments of the present disclosure. According to one embodiment, method 200 preferably begins at step 202. As noted above, teachings of the present disclosure may be implemented in a variety of configurations of smart device 100. As such, the preferred initialization point for method 200 and the order of the steps 202-298 comprising method 200 may depend on the implementation chosen.

At step 202, processor 102 may begin executing document viewer module 106. For example, a user of smart device 100 may communicate via one or more touches at display 104 a desire to execute document viewer module 106. As another example, an email viewing application may invoke document viewer module 106 in response to a user desire to open a document attached to an email.

At step 204, document viewer module 106 may invoke view module 110, and view module 110 may begin executing on processor 102. At step 206, display module 126 of view module 110 may read base document 132 and document metadata 134 associated with it.

At step 208, display module 126 may display the document and various data fields based on the information read at step 206, as well as user options, to display 104, as shown in FIG. 3A, for example. As shown in FIG. 3A, all or a portion of the document and its associated fields may be displayed, along with various user options that a user may select by touching display 104 in a particular location. The functionality of the various options shown in FIG. 3A are described in greater detail below.

At step 210, event module 124 of view module 110 may monitor for tactile touch events occurring at display 104. Such events may indicate a user selection of an option or a user manipulation of the document being viewed within document viewer module 106.

At step 212, event module 124 may determine if the portion of display 104 proximate to the displayed “Inbox” option has been touched. If the portion of display 104 proximate to the displayed “Inbox” option is touched, method 200 may proceed to step 214. Otherwise, method 200 may proceed to step 216.

At step 214, in response to a determination that the portion of display 104 proximate to the displayed “Inbox” option has been touched, document viewer module 106 may close and smart device 100 may return to an email viewing program. After step 214, method 200 may end. In some embodiments, an option such as “Exit” or “Close” may be displayed instead of “Inbox” at display 104. Selection of such an “Exit” or “Close” option may similarly exit document viewer module 106.

At step 216, event module 124 may determine if the portion of display 104 proximate to the displayed “Transmit” option has been touched. If the portion of display 104 proximate to the displayed “Transmit” option is touched, method 200 may proceed to step 217. Otherwise, method 200 may proceed to step 218.

At step 217, in response to a determination that the portion of display 104 proximate to the displayed “Transmit” option has been touched, document viewer module 106 may close and invoke an email program or other program that allows the user to transmit the document from smart device 100 (e.g., via email attachment or text message attachment). In some embodiments, base document 132 and its associated metadata 134 may be merged into a single file prior to transmission. In the same or alternative embodiments, event module 124 may cause base document 132, its associated metadata 134, or a file merging base document 132 and its associated metadata 134 to be stored on memory 103 or another computer-readable medium of smart device 100 prior to transmission. After completion of step 217, method 200 may end. In some embodiments, an option such as “Save” may be displayed instead of “Transmit” at display 104. Selection of such a “Save” option may cause base document 132, its associated metadata 134, or a file merging base document 132 and its associated metadata 134 to be stored on memory 103 or another computer-readable medium of smart device 100.

At step 218, event module 124 may determine if the portion of display 104 proximate to the displayed “Erase” option has been touched. If the portion of display 104 proximate to the displayed “Erase” option is touched, method 200 may proceed to step 220. Otherwise, method 200 may proceed to step 222.

At step 220, in response to a determination that the portion of display 104 proximate to the displayed “Erase” option has been touched, erase module 114 may be executed by processor 102. Erase module 114 may erase or delete all of a portion of the field data 136 associated with the document being viewed in document viewer module 106. After completion of step 220, erase module 114 may close, and method 200 may proceed again to step 210.

At step 222, event module 124 may determine if the portion of display 104 proximate to the displayed “Help” option has been touched. If the portion of display 104 proximate to the displayed “Help” option is touched, method 200 may proceed to step 224. Otherwise, method 200 may proceed to step 226.

At step 224, in response to a determination that the portion of display 104 proximate to the displayed “Help” option has been touched, help module 116 may be executed by processor 102. Help module 116 may display to display 104 various graphical images and/or alphanumeric characters to instruct or advise the user on the effective use of document viewer module 106. After completion of step 224, help module 116 may close, and method 200 may proceed again to step 210.

At step 226, event module 124 may determine if the portion of display 104 proximate to the displayed “+” option has been touched. If the portion of display 104 proximate to the displayed “+” option is touched, method 200 may proceed to step 228. Otherwise, method 200 may proceed to step 244.

At step 228, in response to a determination that the portion of display 104 proximate to the displayed “+” option has been touched, add field dialog module 118 may be executed by processor 102. Add field dialog module 118 may display via display 104 various graphical images and/or alphanumeric characters to present a user with further options regarding the type of data field the user desires to add to the document (e.g., signature, text, date, check, etc.), such as depicted in FIG. 3B, for example. Field dialog module 118 may then monitor for touch events on display 104 that may indicate the type of field the user desires to add.

At step 230, add field dialog module 118 may determine if the portion of display 104 proximate to the displayed “Signature” option has been touched. If the portion of display 104 proximate to the displayed “Signature” option is touched, method 200 may proceed to step 232. Otherwise, method 200 may proceed to step 234.

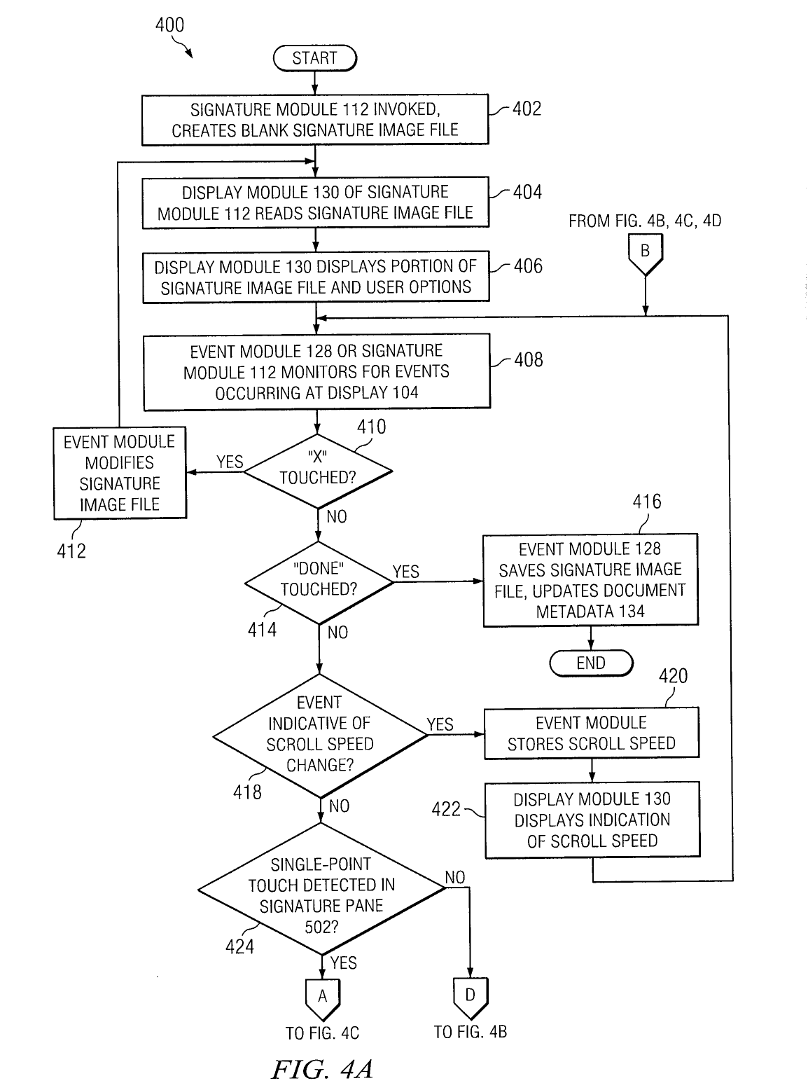

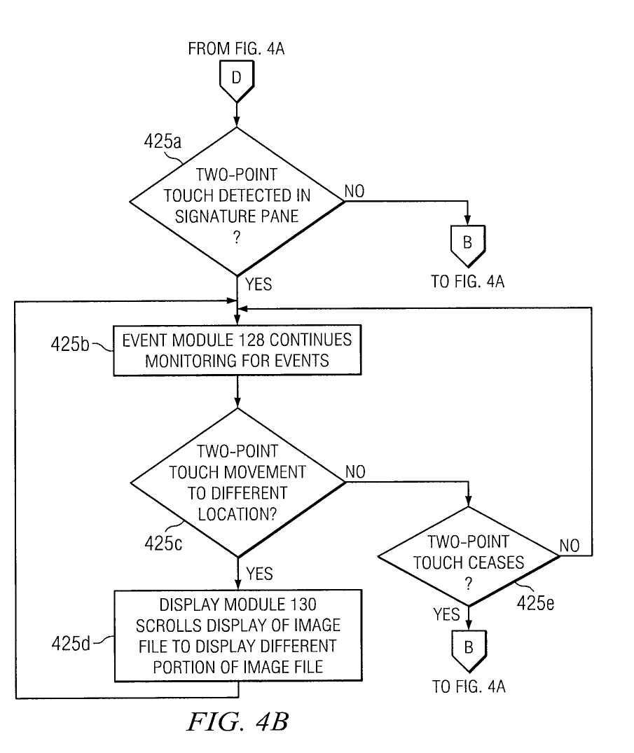

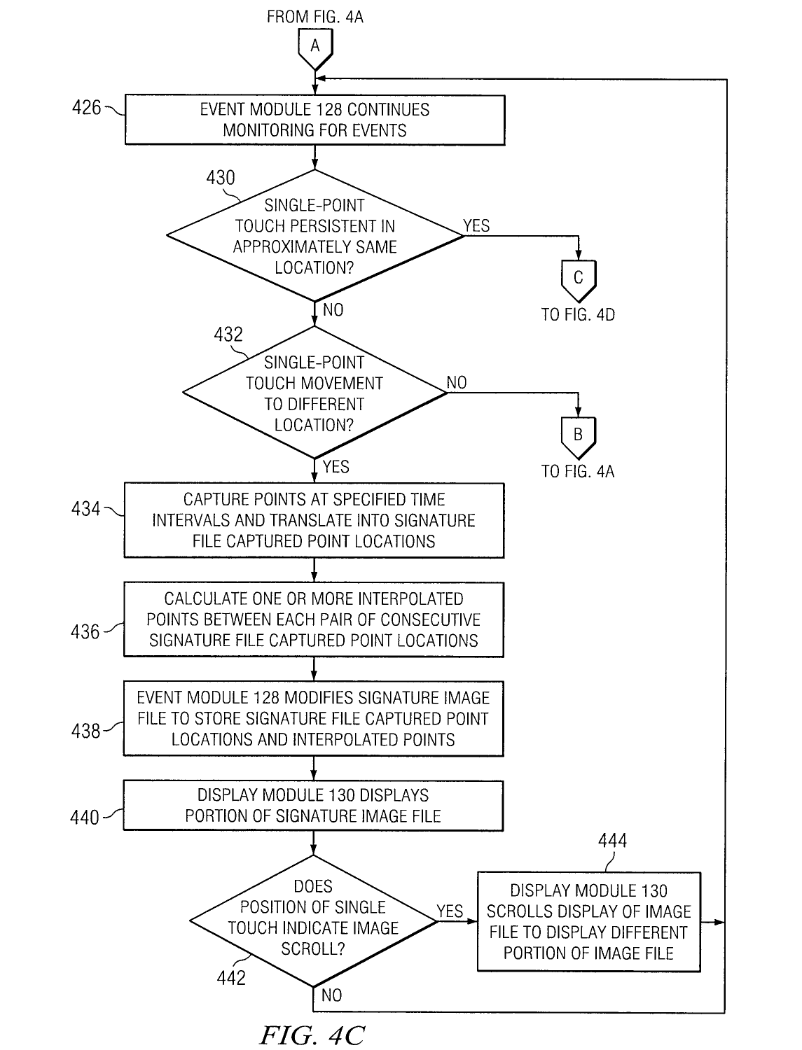

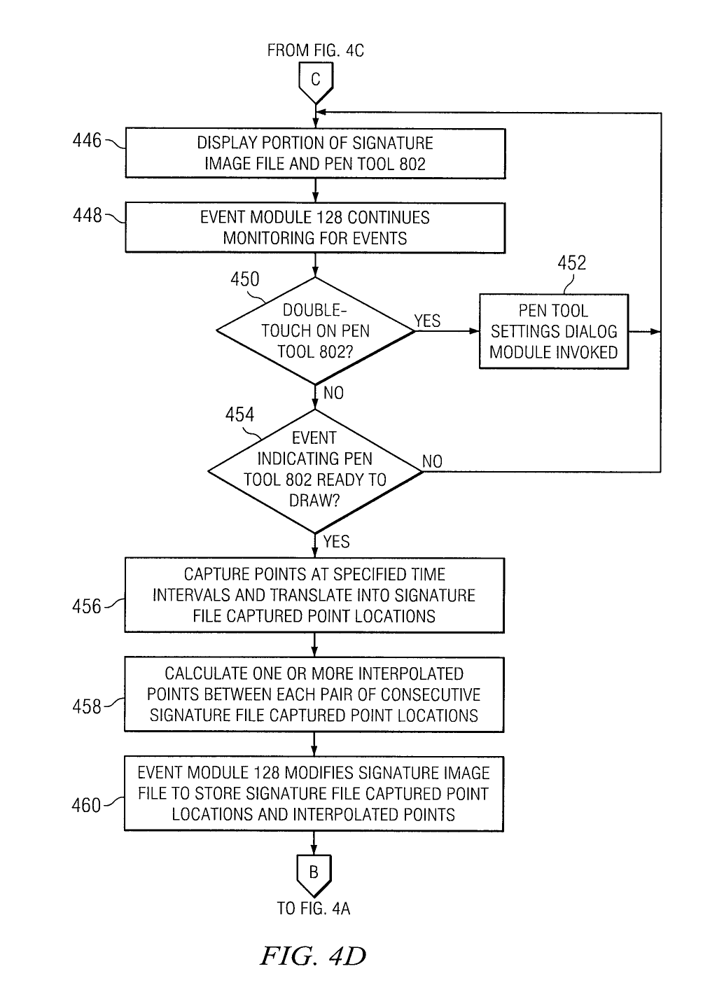

At step 232, in response to a determination that the portion of display 104 proximate to the displayed “Signature” option has been touched, signature module 112 may be executed by processor 102. As noted above, signature module 112 may be configured to display graphical components to display 104 to facilitate the collection of a user signature and to monitor and process touch events at display 104 in order to store an electronic representation of the user's signature for use in connection with the document, such depicted in FIG. 3C, for example. The functionality of signature module 112 is discussed in greater detail below with respect to FIGS. 4A-8E. After signature module 112 has exited, method 200 may proceed to step 242.

At step 234, add field dialog module 118 may determine if the portion of display 104 proximate to the displayed “Text” option has been touched. If the portion of display 104 proximate to the displayed “Text” option is touched, method 200 may proceed to step 232. Otherwise, method 200 may proceed to step 238.

At step 236, in response to a determination that the portion of display 104 proximate to the displayed “Text” option has been touched, text module 120 may be executed by processor 102. As noted above, text module 120 may be configured to display graphical components to display 104 to facilitate the input of text and to monitor and process touch events at display 104 in order to store a field of text in connection with the document being viewed via document viewer module 106. After text module 120 has exited, method 200 may proceed to step 242.

At step 238, add field dialog module 118 may determine if the portion of display 104 proximate to the displayed “Date” option has been touched. If the portion of display 104 proximate to the displayed “Date” option is touched, method 200 may proceed to step 240. Otherwise, method 200 may proceed to step 241a.

At step 240, in response to a determination that the portion of display 104 proximate to the displayed “Date” option has been touched, date module 122 may be executed by processor 102. As noted above, date module 122 may be configured to display graphical components to display 104 to facilitate the placement of a date field within the document being viewed within document viewer module 106 and to monitor and process touch events at display 104 in order to store a field including a date in connection with the document. After date module 122 has exited, method 200 may proceed to step 242.

At step 241a, add field dialog module 118 may determine if the portion of display 104 proximate to the displayed “Check” option has been touched. If the portion of display 104 proximate to the displayed “Check” option is touched, method 200 may proceed to step 241b. Otherwise, method 200 may proceed to step 243.

At step 241b, in response to a determination that the portion of display 104 proximate to the displayed “Check” option has been touched, check module 123 may be executed by processor 102. As noted above, check module 123 may be configured to display graphical components to display 104 to facilitate the placement of a check mark, check box, and/or similar mark within the document being viewed within document viewer module 106 and to monitor and process touch events at display 104 in order to store a field including a check mark, check box, and/or similar mark in connection with the document. After check module 123 has exited, method 200 may proceed to step 242.

At step 242, in response to completion of operation of signature module 112, text module 120, date module 122, or check module 123, view module 110 may store data associated with the added data field in document metadata 132. After completion of step 232, method 200 may proceed again to step 206.

At step 244, event module 124 may determine if display 104 has received a scroll event. A scroll event may occur in response to any touch by a user on display 104 that indicates that a user desires to scroll the document such that a different portion of the document is viewable within display 104. For example, on some smart devices 100, a scroll event may occur as a result of a user moving or sliding his/her finger across the surface of display 104. As another example, on some smart devices 100, portions of display 104 may include arrows (e.g., ←, →, ↑, ↓) or another symbol such that a touch event proximate to such arrows or symbol indicates a user's desire to scroll the document. If a scroll event is received, method 200 may proceed to step 246. Otherwise, method 200 may proceed to step 248.

At step 246, in response to a determination that display 104 received a scroll event, display module 126 may update display 104 in accordance with the user's touch input.

At step 248, event module 124 may determine if display 104 has received a zoom event. A zoom event may occur in response to any touch by a user on display 104 that indicates that a user desires to zoom in or zoom out on the document such that the document appears magnified or de-magnified within display 104. For example, on some smart devices 100, a scroll event may occur as a result of a user touching display 104 with two fingers and then moving those two fingers closer together or farther apart from each other while each of the two fingers remains in contact with the display. As another example, on some smart devices 100, portions of display 104 may include symbols (e.g., a plus sign, a minus sign, a picture of a magnifying glass) such that a touch event proximate to such symbols indicates a user's desire to zoom in or zoom out on the document. If a zoom event is received, method 200 may proceed to step 250. Otherwise, method 200 may proceed to step 252.

At step 250, in response to a determination that display 104 received a zoom event, display module 126 may update display 104 in accordance with the user's touch input.

At step 252, event module 124 may determine if a portion of display 104 proximate to an existing data field (e.g., signature field, data field or text field) has been touched. If the portion of display 104 proximate an existing field is touched, method 200 may proceed to step 254. Otherwise, method 200 may proceed again to step 210.

At step 254, in response to a determination that a portion of display 104 proximate to an existing data field has been touched, display module 126 may cause the display of various user options with respect to the data field, as shown in FIG. 3D. For example, as shown in FIG. 3D, a touch received close to an existing data field, such as a signature, may cause the field to be highlighted and one or more options (e.g., “Move,” “Resize,” “Rotate,” “Delete”) to be displayed on display 104.

At step 256, event module 124 may determine if the portion of display 104 proximate to the displayed “Move” option has been touched. If the portion of display 104 proximate to the displayed “Move” option is touched, method 200 may proceed to step 258. Otherwise, method 200 may proceed to step 268.

At step 258, in response to a determination that the portion of display 104 proximate to the displayed “Move” option has been touched, display module 126 may cause the data field to be highlighted and may also cause the data field options (e.g., “Move,” “Resize,” “Rotate,” “Delete”) to cease being displayed, such as shown in FIG. 3E, for example.

At step 260, event module 124 may monitor display 104 for events indicative of the desired movement of the data field and/or document. For example, a user may indicate a desire to move the data field by touching a portion of display 104 proximate to the displayed data field and “drag” the data field to its desired location, as shown in FIG. 3E, for example. Alternatively, the user may indicate a desire to scroll the document independently from the data field by touching a portion of display 104 proximate to the displayed document (but not proximate to the displayed data field) and “scroll” the document independently from the data field.

At step 262, based on events detected at step 260, document viewer module 106 may store updated document metadata 134 associated with the data field (e.g., updating coordinates of the location of the data field within the document).

At step 264 (which may occur substantially simultaneously with step 262), display module 126 may read the updated document metadata 132 and may accordingly update display 104 based on the events detected at step 260.

At step 266, event module 124 may detect whether an event indicative of the user's desire to cease moving the data field is detected. For example, a user may indicate that the move is complete by quickly tapping a portion of display 104, by not touching display for a period of time (e.g., three seconds), or any other appropriate manner. If an event indicative of the user's desire to cease moving the data field is detected, method 200 may proceed again to step 254. Otherwise, method 200 may proceed again to step 260.

At step 268, event module 124 may determine if the portion of display 104 proximate to the displayed “Resize” option has been touched. If the portion of display 104 proximate to the displayed “Resize” option is touched, method 200 may proceed to step 270. Otherwise, method 200 may proceed to step 280.

At step 270, in response to a determination that the portion of display 104 proximate to the displayed “Resize” option has been touched, display module 126 may cause the data field to be highlighted and may also cause a slider bar or other graphical element to appear, such as displayed in FIG. 3F, for example.

At step 272, event module 124 may monitor display 104 for events indicative of the desired resizing of the data field. For example, a user may indicate a desire to enlarge or shrink the data field by touching a portion of display 104 proximate to the displayed slider bar to slide a displayed portion of the slider bar (e.g., a displayed button) left or right as shown in FIGS. 3F, 3G, and 3H.

At step 274, based on events detected at step 272, document viewer module 106 may store updated document metadata 134 associated with the data field (e.g., updating coordinates of the location of the data field within the document and/or the size of the data field).

At step 276 (which may occur substantially simultaneously with step 274), display module 126 may read the updated document metadata 132 and may accordingly update display 104 based on the events detected at step 272. For example, if a user slides the displayed slider button to the left, display module 126 may shrink the data field as shown in FIG. 3G, for example. As another example, if a user slides the displayed slider button to the right, display module 126 may enlarge the data field as shown in FIG. 3H, for example.

At step 278, event module 124 may detect whether an event indicative of the user's desire to cease resizing the field is detected. For example, a user may indicate that the move is complete by quickly tapping a portion of display 104, touching display 104 proximate to another user option, by not touching display for a period of time (e.g., three seconds), or any other appropriate manner. If an event indicative of the user's desire to cease resizing the data field is detected, method 200 may proceed again to step 256. Otherwise, method 200 may proceed again to step 272.

At step 280, event module 124 may determine if the portion of display 104 proximate to the displayed “Rotate” option has been touched. If the portion of display 104 proximate to the displayed “Rotate” option is touched, method 200 may proceed to step 282. Otherwise, method 200 may proceed to step 292.

At step 282, in response to a determination that the portion of display 104 proximate to the displayed “Rotate” option has been touched, display module 126 may cause the data field to be highlighted and may also a slider bar or other graphical element to appear, such as displayed in FIG. 3I, for example.

At step 284, event module 124 may monitor display 104 for events indicative of the desired rotation of the data field. For example, a user may indicate a desire to rotate the data field by touching a portion of display 104 proximate to the displayed slider bar to slide a displayed portion of the slider bar (e.g., a displayed button) left or right as shown in FIGS. 3I, 3J, and 3K.

At step 286, based on events detected at step 284, document viewer module 106 may store updated document metadata 134 associated with the data field (e.g., updating coordinates of the location of the data field within the document and/or the size of the data field).

At step 288 (which may occur substantially simultaneously with step 286), display module 126 may read the updated document metadata 132 and may accordingly update display 104 based on the events detected at step 284. For example, if a user slides the displayed slider button to the left, display module 126 may rotate the data field counterclockwise as shown in FIG. 3J, for example. As another example, if a user slides the displayed slider button to the right, display module 126 may rotate the data field clockwise as shown in FIG. 3K, for example.

At step 290, event module 124 may detect whether an event indicative of the user's desire to cease resizing the field is detected. For example, a user may indicate that the move is complete by quickly tapping a portion of display 104, touching display 104 proximate to another user option, by not touching display for a period of time (e.g., three seconds), or any other appropriate manner. If an event indicative of the user's desire to cease rotating the data field is detected, method 200 may proceed again to step 256. Otherwise, method 200 may proceed again to step 284.

At step 292, event module 124 may determine if the portion of display 104 proximate to the displayed “Delete” option has been touched. If the portion of display 104 proximate to the displayed “Delete” option is touched, method 200 may proceed to step 294. Otherwise, method 200 may proceed to step 297.

At step 294, in response to a determination that the portion of display 104 proximate to the displayed “Delete” option has been touched, document viewer module 106 may delete data associated with the data field from document metadata 134.

At step 296, display module 126 may update display 104 by deleting the data field from display 104. After completion of step 296, method 200 may proceed to step 298.

At step 297, event module 124 may determine if any portion of display 104 not proximate to the displayed options has been touched. Such an event may indicate that a user does not desire to choose any of the displayed options. any portion of display 104 not proximate to the displayed options has been touched, method 200 may again proceed to step 256. Otherwise, method 200 may proceed to step 298.

At step 298, display module 126 may cause the data field options (e.g., “Move,” “Resize,” “Rotate,” “Delete”) to cease being displayed. After completion of step 298, method 200 may proceed again to step 210.

Although FIGS. 2A-2D disclose a particular number of steps to be taken with respect to method 200, it is understood that method 200 may be executed with greater or lesser steps than those depicted in FIGS. 2A-2D. In addition, although FIGS. 2A-2D disclose a certain order of steps to be taken with respect to method 200, the steps comprising method 200 may be completed in any suitable order. Method 200 may be implemented using smart device 100 or any other system operable to implement method 200. In certain embodiments, method 200 may be implemented partially or fully in software embodied in computer-readable media.

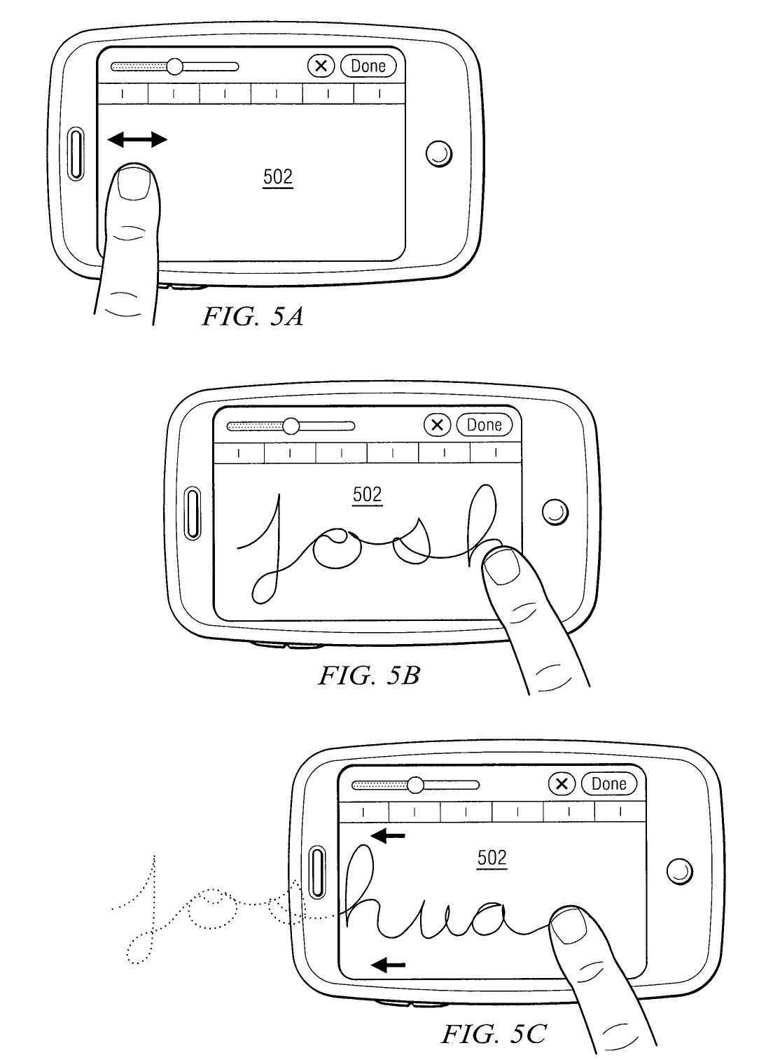

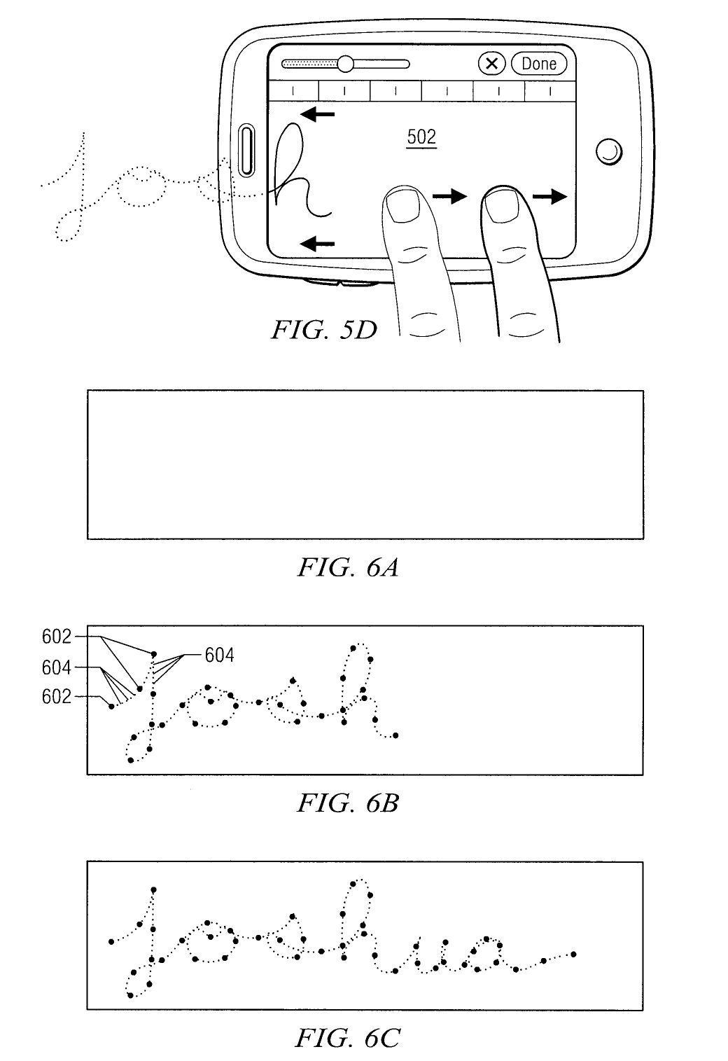

The functionality of signature module 112 be better illustrated by reference to FIGS. 4A-8E. FIGS. 4A-4D illustrate a flow chart of an example method 400 for collecting a signature for insertion into a document, in accordance with one or more embodiments of the present disclosure. FIGS. 5A-5D and 7A-8E illustrate various user interface display screens that may be displayed to a user of a smart device 100 during operation of method 400, in accordance with one or more embodiments of the present disclosure. FIGS. 6A-6C illustrate contents of an image file that may be used to store information regarding a user signature during operation of method 400, in accordance with one or more embodiments of the present disclosure. According to one embodiment, method 400 preferably begins at step 402. As noted above, teachings of the present disclosure may be implemented in a variety of configurations of smart device 100. As such, the preferred initialization point for method 400 and the order of the steps 402-460 comprising method 400 may depend on the implementation chosen.

At step 402, signature module 112 may be invoked by document viewer module 106 and processor 102 may begin executing signature module 112. In some embodiments, signature module 112 may be invoked as a result of a user action, such as a user touching display 104 proximate to a displayed option to add a signature like shown in FIG. 3B, for example. Upon being invoked, signature module may create a blank signature image file (e.g., a bitmap, JPEG, PNG, or other appropriate image file) to be stored as part of field data 136 in document metadata 134. FIG. 6A depicts an example of the contents of a signature image file upon its creation.

At step 404, display module 130 of signature module 112 may read the stored signature image file. At step 406, display module 130 may cause at least a portion of the signature image file to be displayed on display 104 along with user options (e.g., “X,” “Done,” a slider bar, or other graphical user interface elements), such as shown in FIG. 5A, for example. In some embodiments, only a portion of the signature image file may be displayed. For example, a smart device 100 may have a viewable area of 320×480 pixels, an area in which some users may find too small to execute a signature. Accordingly, a signature image file may have a pixel size larger than that of the smart device 100's screen size to accommodate a signature larger than the viewable screen area in size. For example, if smart device 100 has a viewable area of 320×480 pixels, the signature image file may have dimensions of 640×960 pixels. In such embodiments, display 104 may only display a portion of the larger signature image file.

At step 408, event module 128 of signature module 112 may monitor for tactile touch events occurring at display 104. Such events may indicate a user selection of an option or an event indicative of a user's creation or manipulation of a signature.

At step 410, event module 128 may determine if the portion of display 104 proximate to the displayed “X” option has been touched. A touch proximate to the “X” option may indicate that a user may desire to undo all or portion of the actions the user may have taken to create a signature. For example, selection of the “X” option may indicate that the user desires to delete or erase the last “pen stroke” the user made in connection with creating his or her signature. If the portion of display 104 proximate to the displayed “X” option is touched, method 400 may proceed to step 412. Otherwise, method 400 may proceed to step 414.

At step 412, in response to a determination that the portion of display 104 proximate to the displayed “X” option has been touched, event module 128 may modify the signature image file to reflect a user's desire to “undo,” delete” or “erase” a portion of the signature image file. After completion of step 412, method 400 may proceed again to step 404, where the updated signature image may be displayed.

At step 414, event module 128 may determine if the portion of display 104 proximate to the displayed “Done” option has been touched. A touch proximate to the “Done” option may indicate that a user has completed inputting his or her signature and may desire to save the signature. If the portion of display 104 proximate to the displayed “Done” option is touched, method 400 may proceed to step 416. Otherwise, method 400 may proceed to step 418.

At step 416, in response to a determination that the portion of display 104 proximate to the displayed “Done” option has been touched, event module 128 may save the signature image file document metadata 134. After completion of step 416, method 400 may end and signature module 112 may exit.

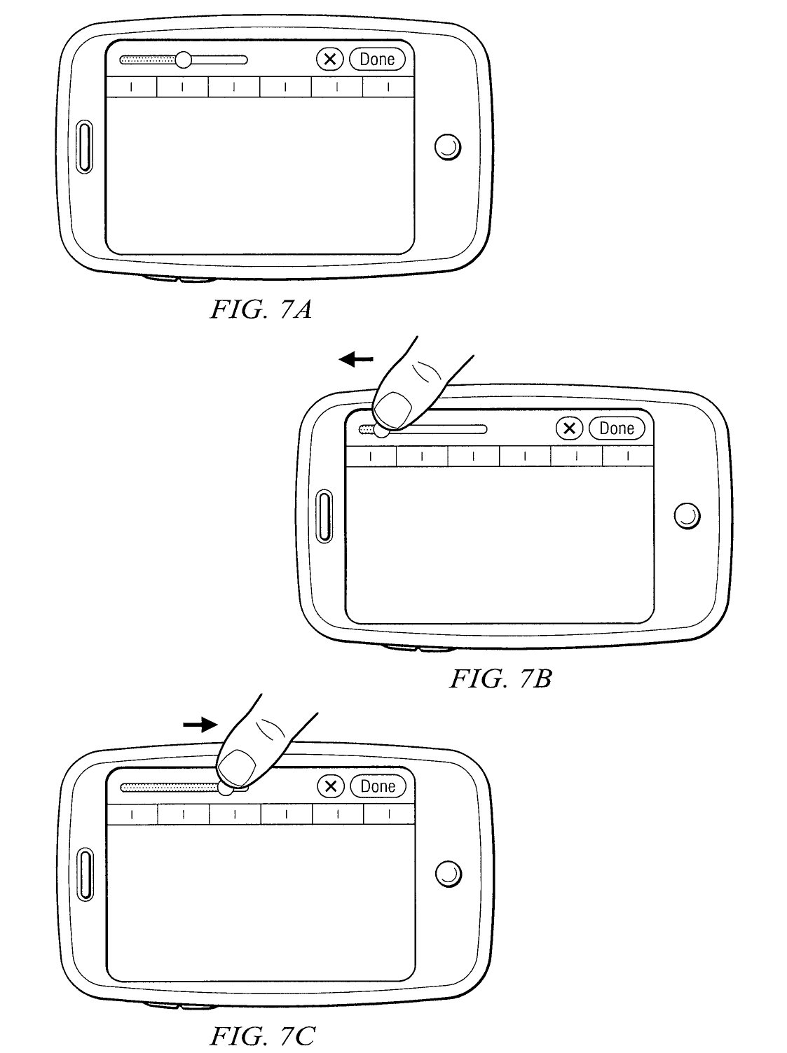

At step 418, event module 128 may determine if an event indicative of a user's desire to alter a signature scroll speed has been detected. As discussed above, the image signature file may be larger than the viewable size of display 104 in order to accommodate signatures larger than the viewable size of display 104. Accordingly, as discussed in greater detail below, signature module 112 may cause display 104 to “scroll” during a user's entry of his or her signature such that it appears to a user as if the signature is moving relative to display 104. This scrolling may permit the user to make continuous “pen strokes” in his or her signature that would otherwise exceed the boundaries of the viewable area of display 104. Because a user may, based on personal preferences, desire to alter or modify the speed at which such scrolling occurs, an option allowing the user to alter the signature scroll speed is appropriate. As an example, a user may indicate a desire to change the signature scroll speed by touching a portion of display 104 proximate to a displayed slider bar to slide a displayed portion of the slider bar (e.g., a displayed button) left or right as shown in FIGS. 7A, 7B, and 7C. If an event indicative of a user's desire to alter a signature scroll speed has been detected, method 400 may proceed to step 420. Otherwise, method 400 may proceed to step 424.

At step 420, in response to a determination that an event indicative of a user's desire to alter a signature scroll speed has been detected, event module 128 may store the new signature scroll speed (e.g., in document metadata 134 or other computer-readable medium).

At step 422 (which may occur substantially simultaneously with step 420), display module 130 may display an indication of the signature scroll speed (e.g., a displayed button may be displayed at a position within the displayed slider bar to indicate the signature scroll speed).

At step 424, event module 128 may determine if a portion of display 104 proximate to signature pane 502 has been touched at a single point (e.g., by one finger of the user). A single-point touch event within signature pane 502 may indicate that a user desires to create a portion of his or her signature (e.g., a pen stroke) or perform another task related to creation of a signature. If a portion of display 104 proximate to signature pane 502 has been touched, method 400 may proceed to step 426. Otherwise, method 400 may proceed to step 425a.

At step 425a, event module 128 may determine if a portion of display 104 proximate to signature pane 502 has been touched at a two points (e.g., by two fingers of the user). A double-point touch event within signature pane 502 may indicate that a user desires to perform a task associated with signature pane 502 other than creating a portion of his or her signature, such as scrolling signature pane 502, for example. If a portion of display 104 proximate to signature pane 502 has been touched at two points, method 400 may proceed to step 425b. Otherwise, method 400 may proceed again to step 408.

At step 425b, in response to a determination that a portion of display 104 proximate to signature pane 502 has been touched at two points, event module 128 may continue to monitor for events at display 104.

At step 425c, event module 128 may determine if the two-point touch detected at step 425a has been persistent on the surface of display 104 within signature pane 502, but at a significantly different location within signature pane 502, as shown in FIG. 5D, for example (e.g., a user has “slid” his or her fingers across a portion of the surface of display 104 proximate to the signature pane 502). Such an event may indicate that the user desires to scroll signature pane 502 such that it displays a different portion of the image file. If the two-point touch detected at step 425a has been persistent on the surface of display 104 within signature pane 502, but at a significantly different location within signature pane 502, method 400 may proceed to step 425d. Otherwise, method 400 may proceed to step 425e.

At step 425d, in response to a determination that the two-point touch detected at step 425a has been persistent on the surface of display 104 within signature pane 502, but at a significantly different location within signature pane 502, display module 130 may display a portion of the signature image file different than that previously displayed such that the signature appears to scroll relative to display 104 in the direction indicated by the user's movements, such as shown in FIG. 5D, for example. After completion of step 425d, method 400 may proceed again to step 425b.

At step 425e, in response to a determination that the two-point touch detected at step 425a has not been persistent on the surface of display 104 within signature pane 502, or is not at a significantly different location within signature pane 502., event module 128 may determine if the two-point touch has ceased (e.g., either one or both of the user's fingers is no longer touching display 104 proximate to signature pane 502). If the two-point touch detected has ceased, method 400 may proceed again to step 408. Otherwise, method 400 may proceed again to step 425b.

At step 426, in response to a determination that a portion of display 104 proximate to signature pane 502 has been touched at a single point, event module 128 may continue to monitor for events at display 104.

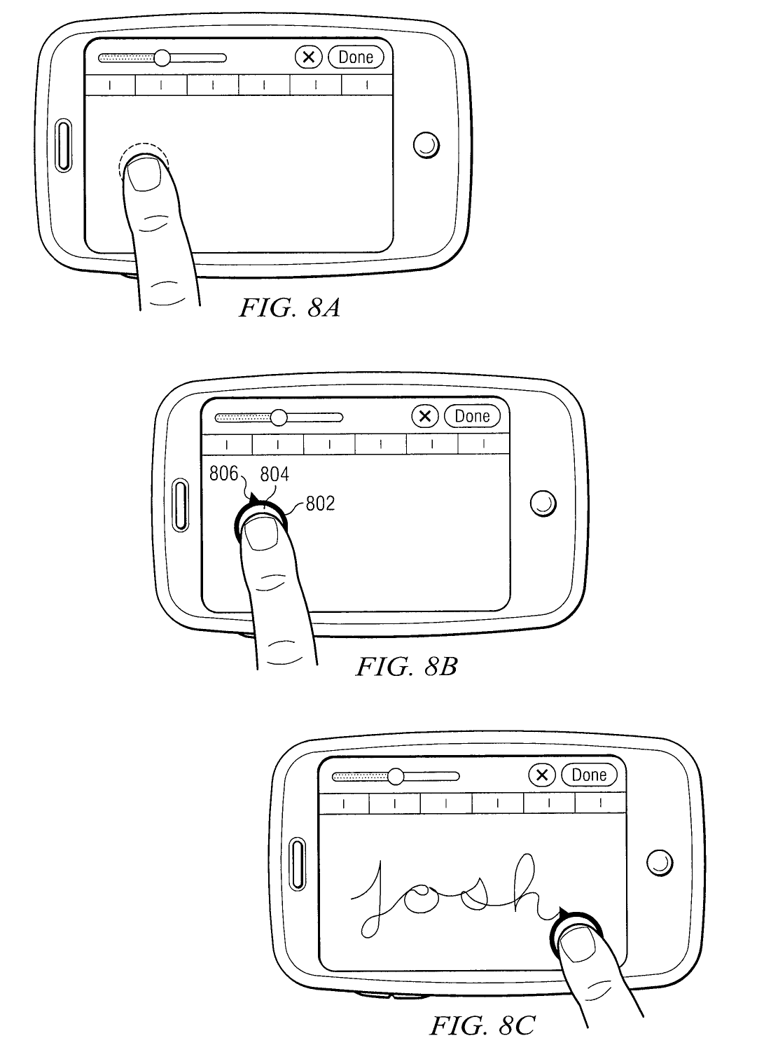

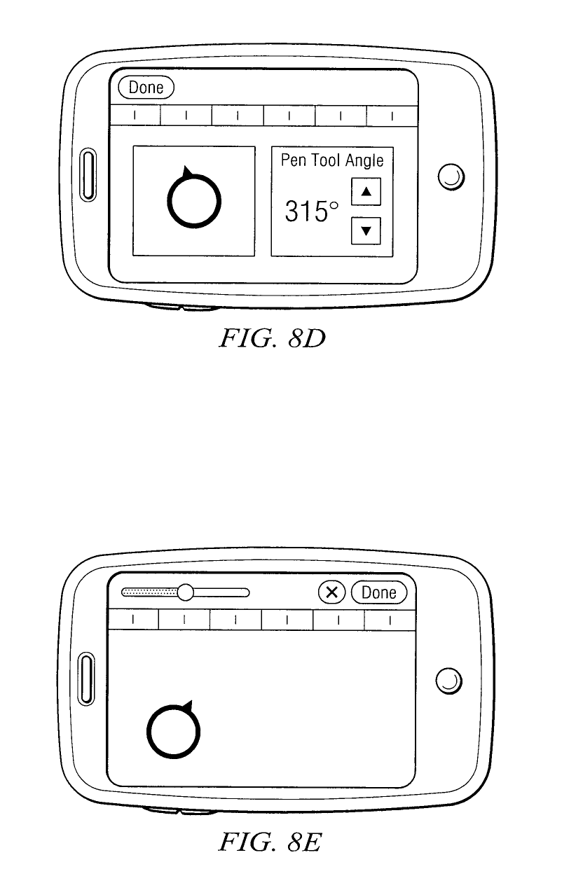

At step 430, event module 128 may determine if the single-point touch detected at step 424 is persistent at approximately the same location of signature pane 502, as shown in FIG. 8A (e.g., the user presses upon the same portion of display 104 within the signature pane 502 for a specified period of time, such as three seconds or more, for example). A persistent single-point touch may indicate that the user desires to invoke special functionality of signature module 112, for example a “pen tool” as discussed in greater detail below. If the single-point touch detected at step 424 is persistent at approximately the same location of signature pane 502, method 400 may proceed to step 446. Otherwise, method 400 may proceed to step 432.

At step 432, event module 128 may determine if the single-point touch detected at step 424 has been persistent on the surface of display 104 within signature pane 502, but at a significantly different location within signature pane 502, as shown in FIG. 5B, for example (e.g., a user has “slid” his or her finger across a portion of the surface of display 104 proximate to the signature pane 502). Such an event may indicate that the user has made or is making a “pen stroke” comprising all or part of the user's signature. If the single-point touch detected at step 424 has been persistent on the surface of display 104 within signature pane 502, but at a significantly different location within signature pane 502, method 400 may proceed to step 434. Otherwise (e.g., the touch at step 424 is a quick touch and release), method 400 may proceed again to step 408.

At step 434, in response to a determination that the single-point touch detected at step 424 has been persistent on the surface of display 104 within signature pane 502, but at a significantly different location within signature pane 502, event module 128 may capture, at regular intervals (e.g., every 50 milliseconds), display point coordinate values corresponding to locations of display 104 that have been touched and translate such display point coordinate values into signature file captured point locations within the signature image file.

At step 436, event module 128 may calculate one or more interpolated points between each pair of consecutive signature file captured point locations. At step 438, event module 128 may modify the signature image file to include points at signature file captured point locations and interpolated points and store the signature image file in document metadata 134 or other computer-readable medium. FIG. 6B depicts as sample image file including points at signature file captured point locations 602 and interpolated points 604. Signature file captured point locations 602 and interpolated points 604 are shown as having different sizes in FIGS. 6B and 6C solely for purposes of exposition, and may be of equal, similar, or different sizes.

At step 440, display module 130 may read the stored signature image file (e.g., from document metadata 134 or other computer-readable medium) and display a portion of the signature image file to display 104. FIG. 5B depicts an example of display 104 that may be displayed if signature image file had contents similar to those shown in FIG. 6B.

At step 442, event module 128 may determine if a position of the detected single-point touch within signature pane 502 indicates that the signature image should be “scrolled” relative to display 104. For example, a detected single-point touch within a certain portion of signature pane 502 (e.g., rightmost one-half of signature pane 502, rightmost one-fourth of signature pane 502) may indicate that the signature image should be scrolled. As another example, a detected single-point touch may indicate that the signature image should be scrolled based on the position of the touch relative to other captured point locations (e.g., a “downstroke” may trigger the commencement of signature scrolling).

At step 444, in response to a determination that a position of the detected single-point touch within signature pane 502 indicates that the signature image should be “scrolled” relative to display 104, display module 130 may display a portion of the signature image file different than that previously displayed such that the signature appears to scroll (e.g., from right to left) relative to display 104, such as shown in FIG. 5C, for example. In some embodiments, signature image file may scroll across display 104 consistent with the set signature scroll speed described above. This scrolling permits a user to enter a signature larger than the viewable size of display 104. As the signature image file appears to scroll across display 104, event module 128 may continue to store captured point locations and interpolated points. To illustrate, FIG. 6C may correspond to an example signature image file stored to document metadata 134 at such time that display 104 appears as depicted in FIG. 5C. After completion of step 444, method 400 may end.

At step 446, in response to a determination that the touch detected at step 424 is persistent at approximately the same location of signature pane 502, display module 130 may display a portion of the signature image file and a pen tool 802, as shown in FIG. 8B, for example. Because some users may have difficulty in inputting a legible or aesthetic signature using such users' fingers, pen tool 802 may allow a user more control over the appearance of his or her signature. For example, by placing one's finger on display 104 proximate to the displayed pen tool base 804, a user may cause pen tool 802 to “move” about display 104 and draw a signature or other image as if there were a virtual pen tip at point 806, as shown in FIG. 8C, for example.

At step 448, event module 128 may continue to monitor for events at display 104.

At step 450, event module 128 may determine if two or more touches in quick succession (e.g., a “double click”) have occurred at display 104 proximate to pen tool 802. Such an event may indicate that a user desires to modify parameters or settings associated with pen tool 802. If two or more touches in quick succession are detected, method 400 may proceed to step 452. Otherwise, method 400 may proceed to step 454.

At step 452, in response to a determination that two or more touches in quick succession are detected, signature module 112 may invoke a pen tool settings module that may allow a user to adjust the angle of point 806 relative to pen tool base 804, such as shown in FIG. 8D, for example. For example, while an angle of 315 degrees may be desirable for a right-handed user, an angle of 45 degrees may be more preferable to a left-handed user. To illustrate, a left-handed user may adjust pen tool settings as shown in FIG. 8D such that the angle of point 806 is at a 45 degree angle, as shown in FIG. 8E. After completion of step 452, method 400 may proceed again to step 446.

At step 454, event module 128 may determine if an event has occurred indicating that a user is ready to draw. For example, a user may persistently touch a portion of display 104 proximate to pen tool base 804 to indicate that he or she is ready to draw, and after a specified period of time (e.g., one second) event module 128 may determine that the user is ready to draw. On the other hand, if a user touches display 104 so as to “drag” pen tool base 804, this may indicate that a user desires to position pen tool 802 in a specific location of signature pad 502 prior to beginning to draw. If it is determined that an event has occurred indicating that a user is ready to draw, method 400 may proceed to step 456. Otherwise, method 400 may proceed again to step 446.

At step 456, in response to a determination that an event has occurred indicating that a user is ready to draw, event module 128 may capture, at regular intervals (e.g., every 50 milliseconds), display point coordinate values corresponding to locations of pen tool point 806 during a user's movement of pen tool 802 (such as shown in FIG. 8C, for example) and translate such display point coordinate values into signature file captured point locations within the signature image file. Accordingly, pen tool 802 may function as a virtual pen allowing the user to “write” his or her signature on display 104 as if a virtual ball point or felt tip were present at point 806.

At step 458, event module 128 may calculate one or more interpolated points between each pair of consecutive signature file captured point locations. At step 460, event module 128 may modify the signature image file to include points at signature file captured point locations and interpolated points and store the signature image file in document metadata 134 or other computer-readable medium. After completion of step 460, method 400 may return again to step 408.

Although FIGS. 4A-4D disclose a particular number of steps to be taken with respect to method 400, it is understood that method 400 may be executed with greater or lesser steps than those depicted in FIGS. 4A-4D. In addition, although FIGS. 4A-4D disclose a certain order of steps to be taken with respect to method 400, the steps comprising method 400 may be completed in any suitable order. Method 400 may be implemented using smart device 100 or any other system operable to implement method 400. In certain embodiments, method 400 may be implemented partially or fully in software embodied in computer-readable media.

Using the methods and systems disclosed herein, a smart device may provide functionality to effectively collect a user signature that may be placed in a document. For example, a signature module may allow a user to input a signature via the smart device display with a pixel size larger than then pixel size of the smart device. In addition, the signature module may provide the user with a pen tool, that functions as a “virtual pen” to allow a user greater control over inputting his or her signature. After a signature has been captured, a document viewer module allows a user to appropriately position and size the signature for placement in a document.

Although the present disclosure has been described in detail, it should be understood that various changes, substitutions, and alterations can be made hereto without departing from the spirit and the scope of the invention as defined by the appended claims.

What is claimed is:

1. A smart device such as the smart device herein shown and described.
